(19) United States
(12) Patent Application Publication
(10) Pub. No.: US 2019/0077373 A1
(43) Pub. Date: Mar. 14, 2019

(54) VEHICLE SENSOR SYSTEM

(71) Applicant: Ford Global Technologies, LLC, Dearborn, MI (US)

(72) Inventors: Mahmoud Yousef Ghannam, Canton, MI (US); Brian Bennie, Sterling Heights, MI (US); Cheri Lyn Hansen, Canton, MI (US); Haron Abdel-raziq, Dearborn, MI (US); Somak Datta Gupta, Novi, MI (US); Cynthia M. Neubecker, Westland, MI (US); Jonathan Diedrich, Carleton, MI (US); Adil Nizam Siddiqui, Farmington Hills, MI (US)

(73) Assignee: Ford Global Technologies, LLC, Dearborn, MI (US)

(21) Appl. No.: 15/699,327

(22) Filed: Sep. 8, 2017

(51) Int. Cl. B60S 1/04; B60R 11/04; B60S 1/56; G01S 7/521

(52) U.S. Cl. CPC B60S 1/0411; B60R 11/04; G01S 2007/4977; G01S 7/521; B60S 1/566

(57) ABSTRACT

A system includes an optical sensor defining a field of view. The system includes a first transparent shield within the field of view. The system includes a second transparent shield movable between a first position and a second position, the first position being within the field of view and spaced from the first shield to define a gap therebetween, the second position being outside the field of view. The system includes a nozzle positioned to direct fluid into the gap.

### BACKGROUND

A vehicle may receive information from an optical sensor. The information from the optical sensor may be used to navigate the vehicle, e.g., to avoid vehicle collisions, maintain a lane of travel, etc. However, the optical sensor may be rendered wholly or partially inoperable, e.g., when a contaminant such as dirt blocks a field of view of the sensor.

### BRIEF DESCRIPTION OF THE DRAWINGS

FIG. 1 is a perspective view of an example vehicle with an example sensor system.

FIG. 2 is a side cross-section view of the example sensor system of FIG. 1 with a second shield in a first position.

FIG. 3 is a side cross-section view of the example sensor system of FIG. 1 with the second shield in a second position.

FIG. 4 is a front view of the example sensor system of FIG. 1 with the second shield in the first position.

FIG. 5 is a front view of the example sensor system of FIG. 1 with the second shield in the second position.

FIG. 6 is a side cross-section view of a portion the example sensor system of FIG. 1 with a wiper in a first position.

FIG. 7 is a side cross-section view of the portion the example sensor system of FIG. 1 with the wiper in a second position.

FIG. 8 is a schematic of a reservoir and a nozzle.

FIG. 9 is a schematic of an air intake and a nozzle.

FIG. 10 is a schematic of an air suspension system and a nozzle.

FIG. 11 is a block diagram of the example vehicle of FIG. 1.

FIG. 12 is an illustration of example images captured by the example sensor system of FIG. 1.

FIG. 13 is a process for operating the example sensor system of FIG. 1.

### DETAILED DESCRIPTION

A system includes an optical sensor defining a field of view. The system includes a first transparent shield within the field of view. The system includes a second transparent shield movable between a first position and a second position, the first position being within the field of view and spaced from the first shield to define a gap therebetween, the second position being outside the field of view. The system includes a nozzle positioned to direct fluid into the gap.

The system may include a second nozzle positioned to direct air into the gap.

The second shield may include a wiper movable between a first position where the wiper is spaced from the first shield and a second position where the wiper abuts the first shield.

The system may include a computer programmed to actuate the wiper between the first position and the second position.

The wiper may include a bladder inflatable to an inflated position, and the wiper is in the second position when the bladder is in the inflated position.

The bladder may be inflated with a hydraulic fluid.

The system may include a pump in communication with the nozzle.

The system may include a computer programmed to actuate the second shield to move from the second position to the first position and to actuate the pump while the second shield is in the first position.

The fluid may be a liquid. The system may include a reservoir in communication with the nozzle and positioned above the nozzle to provide the liquid to the nozzle via gravitational force.

The system may include a reservoir in communication with the nozzle, a valve positioned to control fluid flow from the reservoir to the nozzle, and a computer programmed to actuate the valve while the second shield is in the second position.

The system may include an electromagnetic device configured to move the second shield between the first position and the second position.

The sensor may have a frame rate. The system may include a computer programmed to actuate the second shield between the first position and the second position based on the frame rate.

The first position may be below the second position.

The second shield may include a wiper that extends along the second transparent shield perpendicular to a direction of movement of the second shield between the first position and the second position.

The system may include a second nozzle positioned to direct air into the gap and an air intake in communication with the second nozzle.

The system may include a valve positioned to control air flow from the air intake to the second nozzle and a computer programmed to actuate the valve while the second shield is in the second position.

The system may include a second nozzle positioned to direct air into the gap and an air suspension system in communication with the second nozzle.

The system may include a computer programmed to actuate the air suspension system to provide air to the second nozzle while the second shield is in the second position.

The system may include a computer programmed to actuate the second shield to move between the first position and the second position based on a contamination risk to the first shield.

The system may include a user interface and a computer programmed to actuate the second shield to move between the first position and the second position based on an input to the user interface.

With reference to the Figures, a sensor system 20 for a vehicle 22 includes an optical sensor 24 defining a field of view FV. The system 20 includes a first transparent shield 26 within the field of view FV. The system 20 includes a second transparent shield 28 movable between a first position and a second position, the first position being within the field of view FV and spaced from the first shield 26 to define a gap 30 therebetween, the second position being outside the field of view FV. The system 20 includes a first nozzle 32 positioned to direct fluid into the gap 30. The sensor system 20 protects the optical sensor 24 from conditions such as rain, snow, dirt, etc., and aids in maintaining an uncontaminated field of view FV.

The optical sensor 24 detects light. The optical sensor 24 may be a scanning laser range finder, a light detection and ranging (LIDAR) device, an image processing sensor such as a camera, or any other sensor that detects light. The optical sensor 24 may be supported by a base 34. The optical sensor 24 may be fixed to the base 34 to prevent relative movement therebetween.

The optical sensor 24 defines the field of view FV. The field of view FV is an area relative to the optical sensor 24 from which light is detected by the optical sensor 24. Light generated by, and/or reflected off, an object within the field of view FV, and towards the optical sensor 24, is detectable by the optical sensor 24, provided such light is not blocked before reaching the optical sensor 24. The field of view FV may be circular. For example, the field of view FV may be defined by an angular range, e.g., 90 degrees, rotated about an axis relative to an orientation of the optical sensor 24. The field of view FV may be rectangular. For example, the field of view FV may be defined by a horizontal angular range, e.g., 90 degrees, and a vertical angular range, e.g., 60 degrees. Similarly, the field of view FV may be square.

The optical sensor 24 may have a frame rate, e.g., 42 frames per second. Each frame 40 may be captured as data representing an image 25 of the field of view FV. The optical sensor 24 may have a fixed frame rate, e.g., 100 frames per second. The optical sensor 24 may vary the frame rate, e.g., in response on an instruction from a computer 36.

The base 34 may be formed of metal, plastic, or any other suitable material. The base 34 may include a track 38. The track 38 may be defined by one or more channels, grooves, lips, etc. The base 34 may be a component of the vehicle 22.

The first transparent shield 26 protects the optical sensor 24, e.g., from dirt, water, and other objects that may damage the optical sensor 24. The first transparent shield 26 is positioned within the field of view FV of the optical sensor 24. The first shield 26 permits light to pass therethrough to the optical sensor 24. The first shield 26 may be a lens, e.g., the first shield 26 may focus light onto the optical sensor 24. The first shield 26 may be formed of glass, plastic or other suitable transparent material. The first shield 26 may be supported by the optical sensor 24, e.g., as a component of the optical sensor 24. The first shield 26 may be supported by the base 34. The first shield 26 may be fixed to the base 34 to prevent relative movement therebetween.

The second transparent shield 28 protects the first shield 26, e.g., from dirt, water and other objects that may damage and/or contaminate the first shield 26. The second shield 28 may be made of glass, plastic, or other suitable transparent material. The second shield 28 may include a frame 40, e.g., bordering the transparent material. The frame 40 may be made of metal, plastic, or other suitable material. The second shield 28 may include a permanent magnet 42, e.g., fixed to the frame 40 and/or transparent material with an adhesive, a fastener, etc.

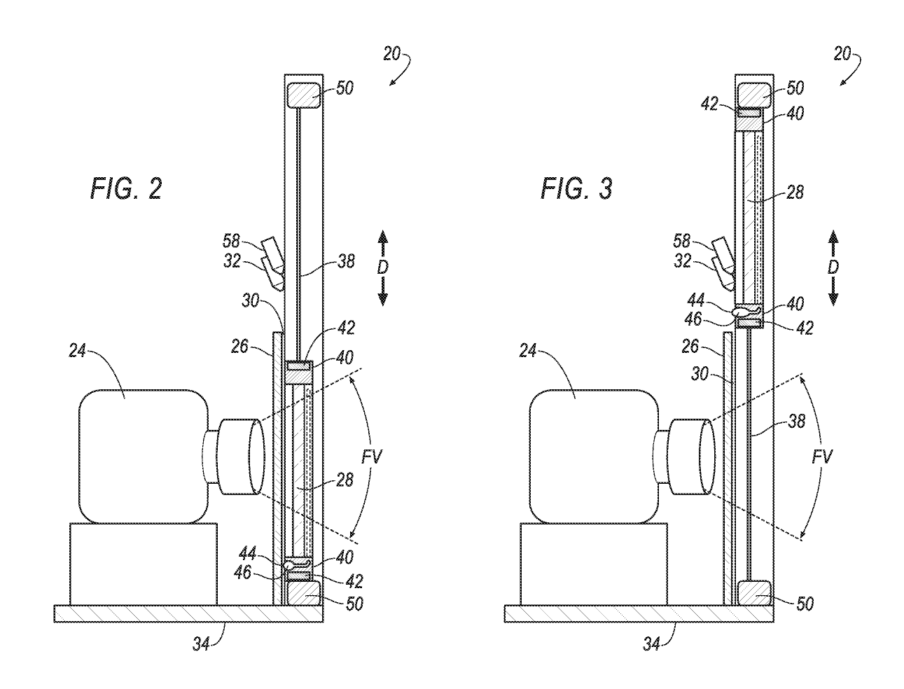

The second transparent shield 28 is movable between the first position, shown in FIGS. 2, 4, 6 and 7, and the second position, shown in FIGS. 3 and 5. For example, the frame 40 of the second shield 28 may be slidably received in the track 38. The second shield 28 may travel, e.g., slide, along the track 38 to translate between the first position and the second position. The first position may be below the second position.

The second shield 28 in the first position is positioned within the field of view FV of the optical sensor 24. The second shield 28 permits light to pass therethrough to the first shield 26. For example, the first shield 26 may be located between the optical sensor 24 and the second shield 28 in the first position.

The second shield 28 in the first position is spaced from the first shield 26 to define the gap 30 therebetween, as shown in FIGS. 2, 6 and 7.

The second shield 28 in the second position is outside the field of view FV of the optical sensor 24. To put it another way, when the second shield 28 is in the second position, light may pass through the first shield 26 and be detected by the optical sensor 24 without passing through the second shield 28.

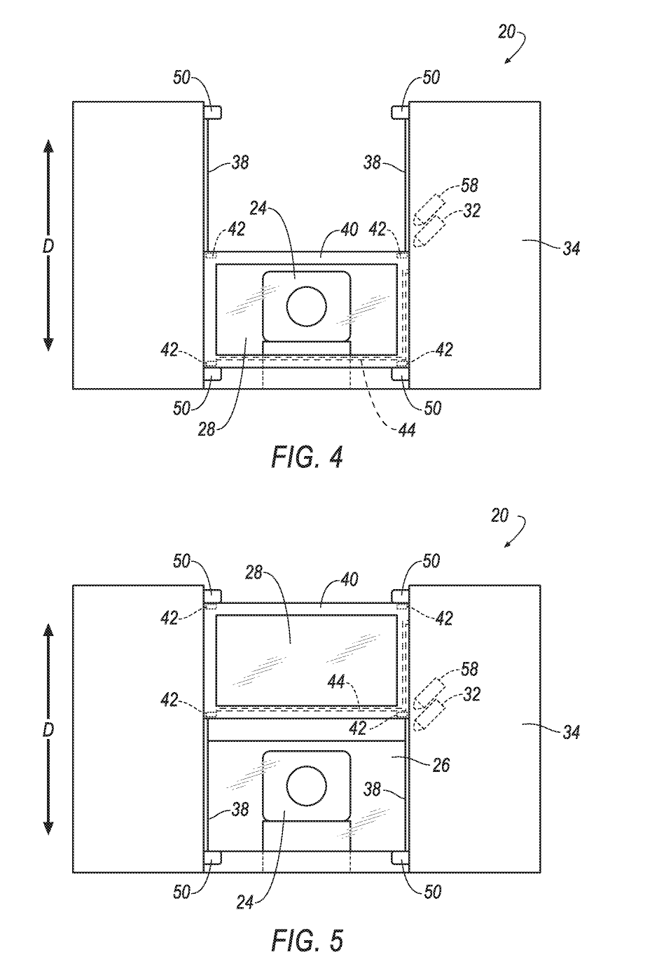

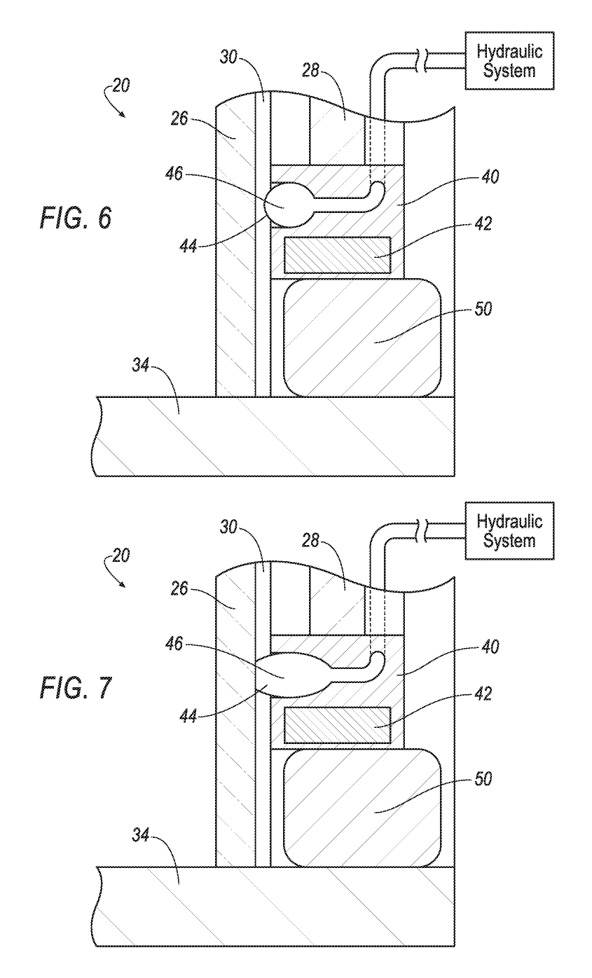

The second shield 28 may include a wiper 44. The wiper 44 is movable between a first position, shown in FIG. 6, and a second position, shown in FIG. 7. In the first position, the wiper 44 is spaced from the first shield 26. In the second position, the wiper 44 abuts the first shield 26. The wiper 44 extends along the second transparent shield 28 perpendicular to a direction D of movement of the second shield 28 between the first position and the second position, as shown in FIGS. 4 and 5. Actuation of the second shield 28 to move between the second position and the first position while the wiper 44 is in the second position causes the wiper 44 to slide along the first shield 26, e.g., to remove contaminants from the first shield 26.

The wiper 44 may include a bladder 46. The bladder 46 is inflatable to an inflated position, shown in FIG. 7. The wiper 44 is in the second position when the bladder 46 is in the inflated position, i.e., inflation of the bladder 46 may cause the wiper 44 to abut the first shield 26.

The bladder 46 may be inflated with a hydraulic fluid. For example, the bladder 46 may be in communication with a hydraulic system 48 configured to add or remove hydraulic fluid to or from the bladder 46. For example, the hydraulic system 48 may include a hydraulic fluid reservoir, a pump, a cylinder and piston, etc. The hydraulic system 48 may actuate to add or remove fluid to or from the bladder 46, e.g., in response to an instruction from the computer 36.

The sensor system 20 may include an electromagnetic device 50 configured to move the second shield 28 between the first position and the second position. The electromagnetic device 50 may include a coil of wire that generates a magnetic field upon actuation, e.g., upon application of an electrical load to the coil. The electromagnetic device 50 may be supported by the base 34 and positioned to attract and/or repel the permanent magnet 42 to move the second shield 28 along track 38. The electromagnetic device 50 may actuate to move the second shield 28, e.g., in response to an instruction from the computer 36. Other electromechanical devices may be used to move the second shield 28 between the first position and the second position, for example, one or more additional electromagnetic devices 50, a spring, a rack and pinion, a linear actuator, etc., including a combination thereof.

The first nozzle 32 is positioned to direct fluid into the gap 30. In one example, the fluid may be a liquid. In the same or another example, the fluid may be gas. For example, the first nozzle 32 may be positioned to spray liquid and/or gas directly into the gap 30. The first nozzle 32 may be positioned to spray liquid above the gap 30 such that gravity draws liquid into the gap 30. The first nozzle 32 may be supported by the base 34.

The first nozzle 32 may be in communication with a reservoir 52 configured to store liquid and/or gas. The reservoir 52 may be a component of the vehicle 22, e.g., part of a windshield washing system of the vehicle 22.

The reservoir 52 may be positioned above the first nozzle 32 to provide liquid to the first nozzle 32 via gravitational force. For example, head pressure from liquid in the reservoir may urge the liquid to the first nozzle 32.

The reservoir 52 may be pressurized, e.g., the reservoir 52 may store gas under pressure. The pressure in the reservoir 52 provides force to urge the fluid to the first nozzle 32.

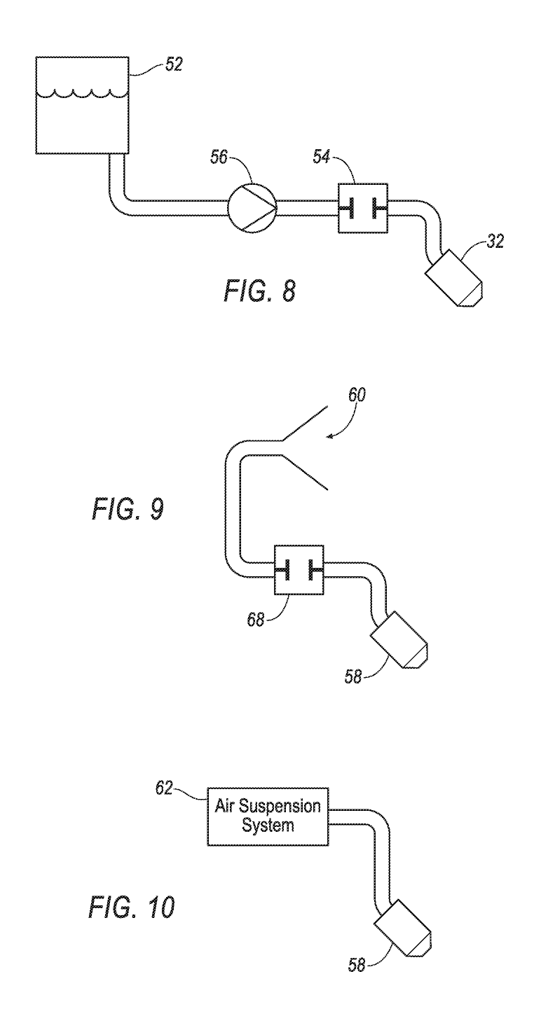

The system 20 may include a valve 54 positioned to control fluid flow from the reservoir 52 to the first nozzle 32, e.g., located in communication with, and between, the reservoir 52 and the first nozzle 32, as shown in FIG. 8. The valve 54 is movable between an open position and a closed position. In the open position fluid is permitted to flow from the reservoir 52 to the first nozzle 32. In the closed position fluid is inhibited from flowing from the reservoir 52 to the first nozzle 32. The valve 54 may include electromechanical components for moving the valve 54 between the open and closed positions, e.g., in response to an instruction from the computer 36.

The system 20 may include a pump 56 in communication with the first nozzle 32. The pump 56 may be in communication with the reservoir 52, as shown in FIG. 8. The pump 56 moves fluid to the first nozzle 32, e.g., from the reservoir 52. The pump 56 actuates between an “on” state and an “off” state. In the “on” state the pump 56 moves fluid. In the “off” state the pump 56 does not move fluid. The pump 56 may actuate between the “on” state and the “off” state, e.g., in response to an instruction from the computer 36.

The system 20 may include a second nozzle 58. The second nozzle 58 is positioned to direct air into the gap 30. Air may be provided to the second nozzle 58 from an air intake 60 (as shown in FIG. 9), an air suspension system 62 (as shown in FIG. 10), a blower, an air compressor, or other mechanical or electromechanical device configured to provide air pressure.

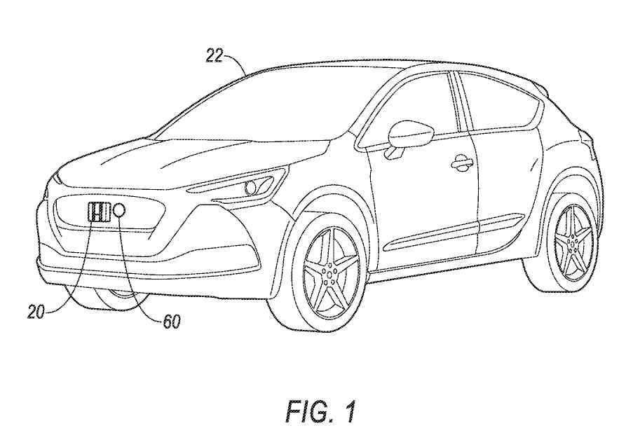

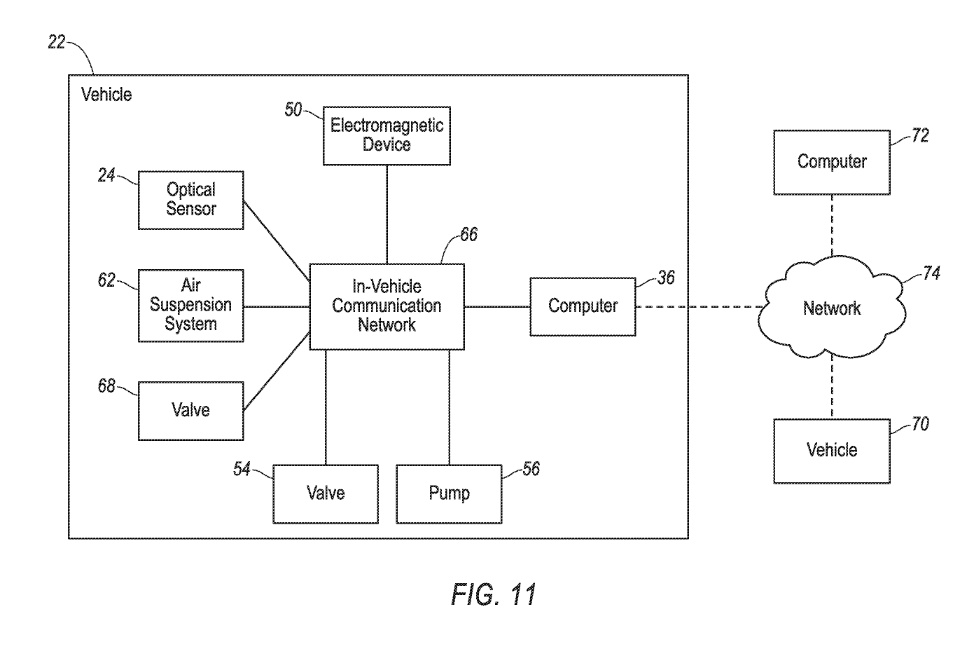

The vehicle 22, shown in FIGS. 1 and 11, may be any passenger or commercial automobile such as a car, a truck, a sport utility vehicle, a crossover vehicle, a van, a minivan, a taxi, a bus, etc. The vehicle 22 may include the sensor system 20, the air intake 60, the air suspension system 62, a user interface 64, an in-vehicle communication network 66, and the computer 36.

The vehicle 22 may operate in an autonomous mode, a semi-autonomous mode, or a non-autonomous mode. For purposes of this disclosure, an autonomous mode is defined as one in which each of a vehicle propulsion, braking, and steering are controlled by the computer 36; in a semi-autonomous mode the computer 36 controls one or two of the vehicle propulsion, braking, and steering; in a non-autonomous mode, a human operator controls the vehicle propulsion, braking, and steering.

The air intake 60 creates air pressure via motion of the vehicle 22, e.g., ram air. The air intake 60 may be in communication with the second nozzle 58. A valve 68 may be positioned to control air flow from the air intake 60 to the second nozzle 58, as shown in FIG. 9. The valve 68 may be movable between an open position and a closed position. In the open position air is permitted to flow from the air intake 60 to the second nozzle 58. In the closed position air is inhibited from flowing from the air intake 60 to the second nozzle 58. The valve 68 may include electromechanical components for moving the valve 68 between the open and closed positions, e.g., in response to an instruction from the computer 36.

The air suspension system 62 absorbs energy and controls motion of wheels of the vehicle 22 relative to a body of the vehicle 22. The air suspension system 62 may be configured to exhaust gas, e.g., in response to an instruction from the computer 36. The air suspension system 62 may be in fluid communication with the second nozzle 58, as shown in FIG. 10. For example, exhaust gas from the air suspension system 62 may flow to the second nozzle 58.

The user interface 64 presents information to, and receives information from, an occupant of the vehicle 22. The user interface 64 may be located, e.g., on an instrument panel in a passenger cabin of the vehicle 22, or wherever may be readily seen by the occupant. The user interface 64 may include dials, digital readouts, screens such as a touch-sensitive display screen, speakers, and so on for providing information to the occupant, e.g., human-machine interface (HMI) elements. The user interface 64 may include buttons, knobs, keypads, microphone, and so on for receiving information from the occupant.

The in-vehicle communication network 66 includes hardware, such as a communication bus, for facilitating communication among vehicle 22 components. The in-vehicle communication network 66 may facilitate wired or wireless communication among the vehicle 22 and system 20 components in accordance with a number of communication protocols such as controller area network (CAN), Ethernet, WiFi, Local Interconnect Network (LIN), and/or other wired or wireless mechanisms.

The computer 36 may be a microprocessor-based computer 36 implemented via circuits, chips, or other electronic components. For example, the computer 36 may include a processor, a memory, etc. The memory of the computer 36 may include memory for storing programming instructions executable by the processor as well as for electronically storing data and/or databases. The computer 36 is generally configured for communications with vehicle 22 components, on a controller area network (CAN) bus, e.g., the in-vehicle communication network 66, and for using other wired or wireless protocols to communicate with devices outside the vehicle 22, e.g., Bluetooth®, IEEE 802.11 (colloquially referred to as WiFi), satellite telecommunication protocols, and cellular protocols such as 3G, LTE, etc. Via the in-vehicle communication network 66 the computer 36 may transmit messages, information, data, etc., to various devices and/or receive messages, information, data, etc., from the various devices. Although the computer 36 is shown as a component of the vehicle 22, it is to be understood that the computer 36 could be a component of the sensor system 20, e.g., in communication with the optical sensor 24 and supported by the base 34. Although one computer 36 is shown in FIG. 11 for ease of illustration, it is to be understood that the computer 36 could include, and various operations described herein could be carried out by, one or more computing devices.

The computer 36 may communicate with other computing devices, e.g., another vehicle 70, another computer 72, e.g., a server computer, etc., via a network 74. The network 74 (sometimes referred to as a wide area network because it can include communications between devices that are geographically remote from one another) represents one or more mechanisms by which remote devices may communicate with each other. Accordingly, the network 74 may be one or more wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary networks 74 include wireless communication networks (e.g., using Bluetooth, IEEE 802.11, etc.), local area networks (LAN) and/or wide area networks (WAN), including the Internet, providing data communication services.

The computer 36 is programmed to identify the frame rate of the optical sensor 24. For example, the computer 36 may receive a message from the optical sensor 24 indicating the frame rate, the computer 36 may instruct the optical sensor to operate at a certain frame rate, etc.

The computer 36 is programmed to actuate the second shield 28 to move between the first position and the second position. For example, the computer 36 may transmit an instruction to the electromagnetic device 50, e.g., to generate a magnetic field, and/or other electromechanical devices, e.g., via the in-vehicle communication network 66. The instruction may instruct actuation of the second shield 28 from the first position to the second position. The instruction may instruct actuation of the second shield 28 from the second position to the first position.

The computer 36 may be programmed to actuate the second shield 28 based on the frame rate. For example, the computer 36 may instruct actuation of the second shield 28 such that the second shield 28 is in the first position every fifth frame. For example, the computer 36 may instruct actuation of the second shield 28 to the first position, wait one frame, then instruct the actuation of the second shield 28 to the second position, wait four frames, and then instruct actuation of the second shield 28 back to the first position, and so on.

The computer 36 may be programmed to actuate the second shield 28 based on a contamination risk to the first shield 26. As used herein, the contamination risk is a likelihood that the first shield 26 is, or will be, contaminated, e.g., by rain, dirt, etc. When the first shield 26 is contaminated the image 25 captured by the optical sensor 24 may not provide sufficient information to the computer 36, i.e., the image 25 may be blocked, blurred, etc., to an extent that such image 25 is of limited use, e.g., to be used by the computer 36 to navigate the vehicle 22. The contamination risk may be identified, for example, as a high risk or a low risk.

The computer 36 may identify the contamination risk based on received information indicating weather conditions, e.g., from another computer 72 via the network 74. For example, the computer 36 may store a lookup table or the like associating various weather conditions, including a timing of such condition, with a high risk. A sample table is shown below.

| Weather Condition | Timing | Contamination Risk |
|---|---|---|
| Raining | Currently | High |
| Raining | Within Past 30 Minutes | High |
| Snowing | Currently | High |
| Snowing | Within Past 30 Minutes | High |

To identify the contamination risk as high, the computer 36 may compare the information indicating weather conditions with the lookup table. When the weather condition is not associated with the high contamination risk the computer 36 may identify the contamination risk as low.

The contamination risk may be identified based on information from the optical sensor 24, and or other sensors of the vehicle 22. For example, the computer 36 may analyze information from the optical sensor 24, e.g., using image 25 recognition processes and methods, to identify rain or other environmental factors external to the vehicle 22 that may pose a contamination risk to the first shield 26. Upon identifying such factors the computer 36 may identify the contamination risk as high.

Similarly, the contamination risk may be identified based on information from another vehicle 72, e.g., information from an optical sensor supported on the other vehicle 72, a message indicating weather conditions from the other vehicle 72, etc.

When the contamination risk is identified as high, the computer 36 may actuate the second shield 28 to move between the first and second positions. When the contamination risk is identified as high, the computer 36 may actuate the second shield 28 to move between the first and second positions at a higher frequency as comparted to when the contamination risk is identified as low.

The computer 36 may be programmed to actuate the second shield 28 based on an input to the user interface 64. For example, upon receipt of a user input, the user interface 64 may transmit a message to the computer 36 indicating such input. Upon receipt of the message, the computer 36 may transmit an instruction, e.g., to move the second shield 28 from the first position to second position, and vice versa, as described herein.

The computer 36 way be programmed to actuate the wiper 44 between the first position and the second position. For example, the computer 36 may transmit an instruction to the hydraulic system 48 to apply, or remove, hydraulic fluid from the bladder 46, thereby transitioning the bladder 46 from the uninflated position to the inflated position, and vice versa.

The computer 36 may be programmed to actuation the wiper 44 upon on a determination that the first shield 26 is contaminated. The computer 36 may determine that the first shield 26 is contaminated based on information from the optical sensor 24, e.g., using image 25 recognition processes and methods.

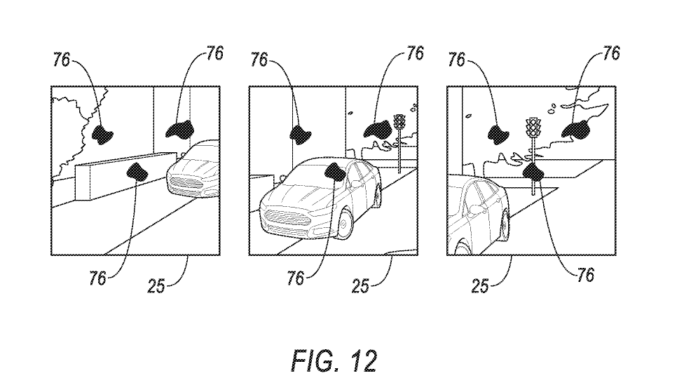

For example, the computer 36 may compare images 25, shown in FIG. 12, received from the optical sensor 24 with each other and identify an artifact 76 that is consistent among the images 25, e.g., dirt on the first shield 26 will appear in a consistent location on the images 25 while a remainder of the image 25 will change. Upon identification of a threshold amount, e.g., a number, a total area, etc., of artifacts 76 the computer 36 may determine the first shield 26 is contaminated. The area of the artifacts 76 may be compared to a threshold area, e.g., 5 percent of the field of view FV. The number of artifacts 76 may be compared to a threshold amount, e.g., 10 artifacts 76. When the area and/or number of artifacts 76 is greater than the threshold area and/or threshold amount, the computer 36 may determine the first shield 26 is contaminated.

For example, the computer 36 may identify the images 25 as being of low quality, e.g., a low resolution resulting from the contamination of the first shield 26 interfering with focusing light on the optical sensor 24. The computer 36 may identify a quality of the image 25, e.g. an image resolution. The computer 36 may compare the quality of the image 25 with a quality threshold e.g., a threshold image resolution value. When the quality of the image 25 is less than the quality threshold the computer 36 may determine the first shield 26 is contaminated. Other techniques may be used to determine that the first shield 26 is contaminated.

The computer 36 may be programmed to actuate the pump 56. For example, the computer 36 may transmit an instruction to the pump 56, e.g., via the in-vehicle communication network 66, to transition from the “off” state to the “on” state, and vice versa. The computer 36 may actuate the pump 56, e.g., to the “on” state, while the second shield 28 is in the first position.

The computer 36 may be programmed to actuate the valve 54 positioned to control fluid flow from the reservoir 52 to the first nozzle 32. For example, the computer 36 may transmit an instruction, e.g., via the in-vehicle communication network 66, to the valve 54 to transition from the closed position to the open position, and vice versa. The computer 36 may instruct the valve 54 to actuate, e.g., to the open position, while the second shield 28 is in the second position.

The computer 36 may be programmed to actuate the valve 68 positioned to control air flow from the air intake 60 to the second nozzle 58. For example, the computer 36 may transmit an instruction, e.g., via the in-vehicle communication network 66, to the valve 68 to transition from the closed position to the open position, and vice versa. The computer 36 may instruct the valve 68 to actuate, e.g., to the open position, while the second shield 28 is in the second position. The computer 36 may actuate the valve 68 an amount of time, e.g., 200 milliseconds, after actuation of the pump 56 and/or the valve 54 positioned to control liquid flow from the reservoir 52 to the first nozzle 32.

The computer 36 may be programmed to actuate the air suspension system 62 to provide air to the second nozzle 58. For example, the computer 36 may transmit an instruction to the air suspension system 62, e.g., via the in-vehicle communication network 66, to provide exhaust gas, as described herein. The computer 36 may instruct the air suspension system 62 to provide gas while the second shield 28 is in the second position. The computer 36 may actuate the air suspension system 62 an amount of time, e.g., 200 milliseconds, after actuation of the pump 56 and/or the valve 54 positioned to control fluid flow from the reservoir 52 to the first nozzle 32. Similarly, the computer 36 may actuate one or more other electromechanical devices, e.g., a blower, configured to provide air pressure.

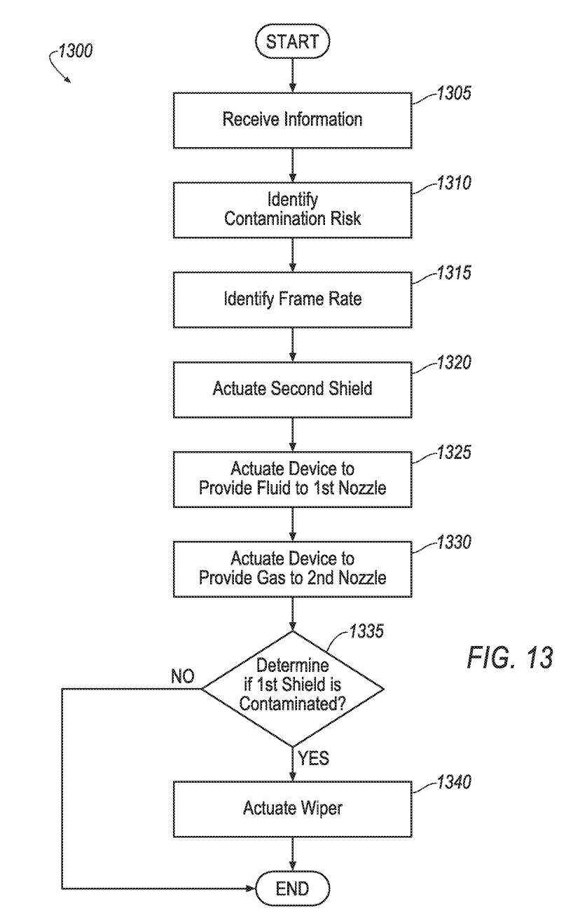

FIG. 13 is a process flow diagram illustrating an exemplary process 1300 for operating the sensor system 20. The process 1300 may be executed by the computer 36. The process 1300 begins in a block 1305 in which the computer 36 receives information, e.g., from the optical sensor 24, from another vehicle 70, from another computer 72, etc. The computer 36 may continue to receive data throughout the process 1300. Throughout the process 1300 means substantially continuously or at time intervals, e.g., every 200 milliseconds.

Next, at a block 1310, the computer 36 identifies the contamination risk, e.g., based on the received information from the block 1305, the lookup table, etc., as described herein.

At a block 1315 the computer 36 identifies the frame rate of the optical sensor 24, as described herein.

Next, at a block 1320 the computer 36 actuates the second shield 28 to move between the first and second positions, e.g., by sending an instruction to the electromagnetic device 50, etc., as described herein. The computer 36 may actuate the second shield 28 based on the frame rate and/or the contamination risk, as described herein.

Next, at a block 1325 the computer 36 actuates the pump 56 and/or the valve 54 positioned to control fluid flow from the reservoir 52 to the first nozzle 32, e.g., by sending an instruction to the pump 56 to transition to the “on” state, and/or to the valve 54 to transition to the open position. The computer 36 may actuate the pump 56 and/or the valve 54 while the second shield 28 is in the first position, as described herein.

Next, at a block 1330 the computer 36 actuates the valve 68 positioned to control air flow from the air intake 60, the air suspension system 62, and/or one or more other electromechanical devices to provide air to the second nozzle 58, e.g., by transmitting an instruction to such device, as described herein. Such actuation may be instructed when the second shield 28 is in the first position. Such actuation may be instructed an amount of time, e.g., 200 milliseconds, after actuation of the pump 56 and/or the valve 54 positioned to control fluid flow from the reservoir 52 to the first nozzle 32.

At a block 1335 the computer 36 determines whether the first shield 26 is contaminated, e.g., based on information from the optical sensor 24, as described herein. Upon a determination that the first shield 26 is contaminated the process moves to a block 1340. Upon a determination that the first shield 26 is not contaminated, the process may end. Alternately, upon the determination the first shield 26 is not contaminated the process may return to the block 1305.

At the block 1340 the computer 36 actuates the wiper 44 to the second position. For example, the computer 36 may instruct the hydraulic system 48 to inflate the bladder 46, as described herein. The computer 36 may actuate the second shield 28 between the first position and the second position while the wiper 44 is in the second position. After the block 1340 the process may end. Alternately, the process may return to the block 1305.

The adjectives “first” and “second” are used throughout this document as identifiers and are not intended to signify importance or order.

As used herein a computing device, e.g., a computer, includes a processor and a memory. The processor is implemented via circuits, chips, or other electronic component and may include one or more microcontrollers, one or more field programmable gate arrays (FPGAs), one or more application specific circuits ASICs), one or more digital signal processors (DSPs), one or more customer integrated circuits, etc. The processor can receive the data and execute the processes described herein.

The memory (or data storage device) is implemented via circuits, chips or other electronic components and can include one or more of read only memory (ROM), random access memory (RAM), flash memory, electrically programmable memory (EPROM), electrically programmable and erasable memory (EEPROM), embedded MultiMediaCard (eMMC), a hard drive, or any volatile or non-volatile media etc. The memory may store data collected from sensors. The memory may store program instruction executable by the processor to perform the processes described herein.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

The phrase “based on” encompasses being partly or entirely based on.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A system, comprising:
an optical sensor defining a field of view;
a first transparent shield within the field of view;
a second transparent shield movable between a first position and a second position, the first position being within the field of view and spaced from the first shield to define a gap therebetween, the second position being outside the field of view; and
a nozzle positioned to direct fluid into the gap.

2. The system of claim 1, further comprising a second nozzle positioned to direct air into the gap.

3. The system of claim 1, wherein the second shield includes a wiper movable between a first position where the wiper is spaced from the first shield and a second position where the wiper abuts the first shield.

4. The system of claim 3, further comprising a computer programmed to actuate the wiper between the first position and the second position.

5. The system of claim 3, wherein the wiper includes a bladder inflatable to an inflated position, and the wiper is in the second position when the bladder is in the inflated position.

6. The system of claim 5, wherein the bladder is inflated with a hydraulic fluid.

7. The system of claim 1, further comprising a pump in communication with the nozzle.

8. The system of claim 7, further comprising a computer programmed to actuate the second shield to move from the second position to the first position and to actuate the pump while the second shield is in the first position.

9. The system of claim 1, wherein the fluid is a liquid, and further comprising a reservoir in communication with the nozzle and positioned above the nozzle to provide the liquid to the nozzle via gravitational force.

10. The system of claim 1, further comprising a reservoir in communication with the nozzle, a valve positioned to control fluid flow from the reservoir to the nozzle, and a computer programmed to actuate the valve while the second shield is in the second position.

11. The system of claim 1, further comprising an electromagnetic device configured to move the second shield between the first position and the second position.

12. The system of claim 1, wherein the sensor has a frame rate, and further comprising a computer programmed to actuate the second shield between the first position and the second position based on the frame rate.

13. The system of claim 1, wherein the first position is below the second position.

14. The system of claim 1, wherein the second shield includes a wiper that extends along the second transparent shield perpendicular to a direction of movement of the second shield between the first position and the second position.

15. The system of claim 1, further comprising a second nozzle positioned to direct air into the gap and an air intake in communication with the second nozzle.

16. The system of claim 15, further comprising a valve positioned to control air flow from the air intake to the second nozzle and a computer programmed to actuate the valve while the second shield is in the second position.

17. The system of claim 1, further comprising a second nozzle positioned to direct air into the gap and an air suspension system in communication with the second nozzle.

18. The system of claim 17, further comprising a computer programmed to actuate the air suspension system to provide air to the second nozzle while the second shield is in the second position.

19. The system of claim 1, further comprising a computer programmed to actuate the second shield to move between the first position and the second position based on a contamination risk to the first shield.

20. The system of claim 1, further comprising a user interface and a computer programmed to actuate the second shield to move between the first position and the second position based on an input to the user interface.
